(19) United States
(12) Patent Application Publication
(10) Pub. No.: US 2017/0081992 A1
(43) Pub. Date: Mar. 23, 2017

(54) METHOD AND DEVICE FOR DIAGNOSE OF VALVES OF AN INTERNAL COMBUSTION ENGINE

(71) Applicant: SCANIA CV AB, Södertälje (SE)

(72) Inventors: Ola STENLÄÄS, Södertälje (SE); Mikael NORDIN, Järna (SE)

(73) Assignee: SCANIA CV AB, Sodertalje (SE)

(21) Appl. No.: 15/312,220

(22) PCT Filed: Jun. 16, 2015
(86) PCT No.: PCT/SE2015/050698

§ 371 Date: Nov. 18, 2016

(30) Foreign Application Priority Data
Jun. 17, 2014 (SE) 1450743-8

(51) Int. Cl. F01L 3/24; F02D 41/22; G01M 15/05

(52) U.S. Cl. CPC F01L 3/24; G01M 15/05; F02D 41/22; F01L 2800/11; F01L 2800/14; F01L 2820/045

(57) ABSTRACT

A method for diagnosis of at least one valve in at least one cylinder in a combustion engine comprising the steps, at a movement of a piston in said cylinder, of detecting movements propagating in a cylinder head of the cylinder or of parts adjacent thereto in the engine, comparing values resulting from the detection step with at least one stored setpoint value, and determining the state of said at least one valve, based on the result of said comparison.

### CROSS-REFERENCE TO RELATED APPLICATION(S)

This application is a national stage application (filed under 35 §U.S.C. 371) of PCT/SE15/050698, filed Jun. 16, 2015 of the same title, which, in turn claims priority to Swedish Application No. 1450743-8, filed Jun. 17, 2014 of the same title; the contents of each of which are hereby incorporated by reference.

### FIELD OF THE INVENTION

The present invention relates to a method and a device for diagnosis of at least one valve in at least one cylinder in a combustion engine.

### BACKGROUND OF THE INVENTION

There is a constant aspiration to achieve control of a combustion engine, in such a manner that fuel used therein is burned in the engine's cylinders, while generating a maximum amount of energy/fuel mass output from the engine and a minimum amount of emissions of environmentally hazardous pollutants. It is of decisive importance in such aspiration to have constant knowledge of the combustion engine's operating conditions, such as the operating condition of the in- and outlet valves of the engine's cylinders.

At a prolonged use of the engine, such valves and therefore the valve seats interacting with them, may be worn so that problems arise, such as when the opening and closing times of the valves do not coincide with those in a newly produced engine. Such valve problems may sometimes lead to increased fuel consumption in the engine and increased emissions. Valves in the engine should thus, to prevent that for example statutory emission values are exceeded, be adjusted or replaced before they are worn to a critical extent.

Usually, diagnosis of valves in combustion engines is not carried out during operation, but instead the valves are examined by a mechanic, when for example the vehicle is taken to a service garage. This procedure is time consuming and expensive, since there is a risk that the engine must be taken apart to check the valves even though they may not need to be replaced. Conversely, at the use of such engines there is also a risk that, for example, a vehicle may drive long distances without maximum energy extraction from the fuel and with unnecessarily high emissions.

One reason why a mechanic is often responsible for diagnosis of the valves in combustion engines may be that the methods available to diagnose such valves during operation often are complex and costly to carry out, since they may, for example, comprise use of expensive sensors and data processing units installed for this purpose.

### SUMMARY OF THE INVENTION

The objective of the present invention is to provide a method and a device, which are improved in at least some respect in relation to prior art methods and devices.

This objective is achieved according to the invention through the method and the device according to the enclosed claims.

It has been shown that when a piston moves in said cylinder, by detecting movements propagating in a cylinder head in the cylinder or in parts adjacent thereto in the engine, and comparing the values resulting from the detection with at least one setpoint value, said state in said at least one valve may be reliably determined.

Accordingly, it becomes possible to diagnose, in a simple manner, the valves in the cylinders of a combustion engine, while the latter is in operation. As a result, this may be carried out without any risk that the engine is dismantled unnecessarily or is operating with unnecessarily high fuel consumption. Further, cost savings thus achieved may be achieved without arranging expensive installations, which are especially adapted to detecting valve errors.

The movements that may be detected and used at diagnosis of said at least one valve may, for example, be vibrations, noise, i.e. gas movements, and various types of shape changes, such as protrusions, in said cylinder head or in parts adjacent thereto in the engine.

According to one embodiment, a method for diagnosis of at least one valve in at least one cylinder in a combustion engine is achieved. The method comprises the steps, at a movement of a piston in said cylinder,
detecting propagating movements in a cylinder head of the cylinder or in parts adjacent thereto in the engine,
comparing values resulting from steps with at least one stored setpoint value, and
determining the state of said at least one valve, based on the result of said comparison.

According to one embodiment of the invention, movements caused by at least one of the following events in said cylinder are detected: positional change in at least one valve and pressure change in a cylinder chamber. It has been shown that said movements caused by one of said events are suitably detected and used for a reliable diagnosis of one or several valves of the type specified above.

According to another embodiment of the invention, at least movements caused by a positional change in at least one valve of said cylinder are detected, wherein said movements are detected at least at one crank angle. Information about such movements and at what crank angle they are detected has been shown to be suitable for use, in order to quickly and comparatively unproblematically determine a state in the at least one valve.

According to another embodiment of the invention, the value of said at least one crank angle is compared with a setpoint value for a crank angle, at which said movements should be detected. Through such a comparative step, diagnosis of one or several valves in an engine may be provided in an uncomplicated manner.

According to another embodiment of the invention, movements caused by at least both said events are detected.

According to another embodiment of the invention, values which result from movements caused by a positional change in at least one valve, a pressure change in a cylinder chamber and a turn of a piston in said cylinder, which—through a value calculated with information about these and about the current speed of the engine, comprising information about at least a crank angle at which said movements caused by said positional change are detected—are compared with said at least one setpoint value for a crank angle, at which said movements caused by said positional change should be detected.

Tests have been carried out and shown that it is possible to detect such movements with cost effective means, and that, with the help of information about the engine's current engine speed, such movements may be used, through comparison with at least one stored setpoint value, to advantageously determine a state in said at least one valve.

According to another embodiment of the invention, said movements caused by said positional change in at least one valve, preferably such movements caused by opening and closing of said valve, are detected at least at two different crank angles.

According to another embodiment of the invention, values resulting from movements caused by a positional change in at least one valve and a pressure change in a cylinder chamber are compared—through a value calculated based on information about these and about the engine's current engine speed, in the form of a period length of a valve period of said valve—with said at least one setpoint value for such a period length. It has been shown that it is possible, with information about said events and about the engine's current engine speed, to diagnose said at least one valve with reliable results.

According to another embodiment of the invention, an error state is determined when said value of said at least one crank angle and/or period length is not within a predetermined interval around said setpoint value, and a normal state is determined when said value of said at least one crank angle and/or period length is within a predetermined interval around said setpoint value. By determining either an error state or a normal state in the valve or valves diagnosed, clear information about the state of said valves is provided, and suitable measures may quickly be taken where needed.

According to another embodiment of the invention, at least movements caused by a pressure change in a cylinder chamber in said cylinder are detected, wherein said movements are detected at least at one crank angle.

According to another embodiment of the invention, a stored setpoint value in the form of a normal pressure in said cylinder chamber at least one specific crank angle, is compared with said value of said detected movements at the at least one specific crank angle, wherein said value of said detected movements comprises information about the pressure in said cylinder chamber.

Through a comparison of the measured pressure at a crank angle in said cylinder chamber, in the form of said detected movements caused by a pressure change in the cylinder chamber, and a setpoint value for the pressure at this crank angle, the valves in a cylinder may be reliably diagnosed with respect to, for example, leakages at one of these.

According to another embodiment of the invention, an error state is determined when said value of said detected movements at the at least one crank angle is not within a predetermined interval around said setpoint value, and a normal state is determined when said value of said detected movements at the at least one crank angle is within a predetermined interval around said setpoint value. Thus, it becomes possible to take direct corrective measures when the diagnosis of the valve or valves shows such a need.

According to another embodiment of the invention, an error state comprising at least two, preferably at least three, different types and/or degrees or error is determined.

According to another embodiment of the invention, the method also comprises the step of sending a warning signal, and/or preventing fuel injection into the cylinder chamber of the relevant cylinder, when the state of said valve is determined to be an error state. Accordingly, it is possible directly to take suitable measures based on the type and/or degree of error that is determined.

According to another embodiment of the invention, the results of the diagnoses are used during several different valve periods, in order to diagnose at least one valve. Accordingly, for example the results of 100 diagnoses during 100 valve periods may be used, and at for example more than 3, 5 or 10 determined error states out of 100, the diagnosis of a valve is determined as a final error state, or an error state of a more serious degree or type.

The invention also relates to a device for diagnosis of at least one valve in at least one cylinder of a combustion engine according to the enclosed independent device claims. The function of such a device and the possibilities it offers are described in the discussion above of the innovative method.

The invention also relates to a computer program, a computer program product, an electronic control device, a combustion engine and a motor vehicle, which functions as described above.

The invention is not limited to any specific type of combustion engine, but encompasses Otto engines as well as compression ignited engines, nor to any specific fuel, non-exhaustive examples of which may comprise fuel in the form of petrol, ethanol, diesel and gas.

Likewise, the invention comprises combustion engines intended for all types of use, such as in industrial applications, in crushing machines and various types of motor vehicles, wheeled motor vehicles as well as trucks and buses, and boats and crawlers or similar vehicles.

Other advantageous features and advantages with the invention are set out in the description below.

### BRIEF DESCRIPTION OF THE DRAWINGS

Below are descriptions of example embodiments of the invention, with reference to the enclosed drawings, in which:

FIG. 1a is a schematic view illustrating a part of a combustion engine according to one embodiment of the invention,

FIG. 1b shows a possible location of a sensor element,

FIG. 2 is an enlarged view corresponding to the dashed area in FIG. 1a, illustrating valves and valve seats in a cylinder head of a cylinder of an engine,

FIG. 3 is a diagram showing on the one hand the pressure in the cylinder chamber of a cylinder in a combustion engine according to the invention over time, and on the other hand several signals generated over time by sensor elements of the combustion engine according to FIG. 1, as a result of detection of movements in the cylinder head,

FIG. 4 is a flow chart showing a method according to one embodiment of the invention, and

FIG. 5 is a fundamental diagram of an electronic control device for implementation of one or several methods according to the invention.

### DETAILED DESCRIPTION OF THE INVENTION

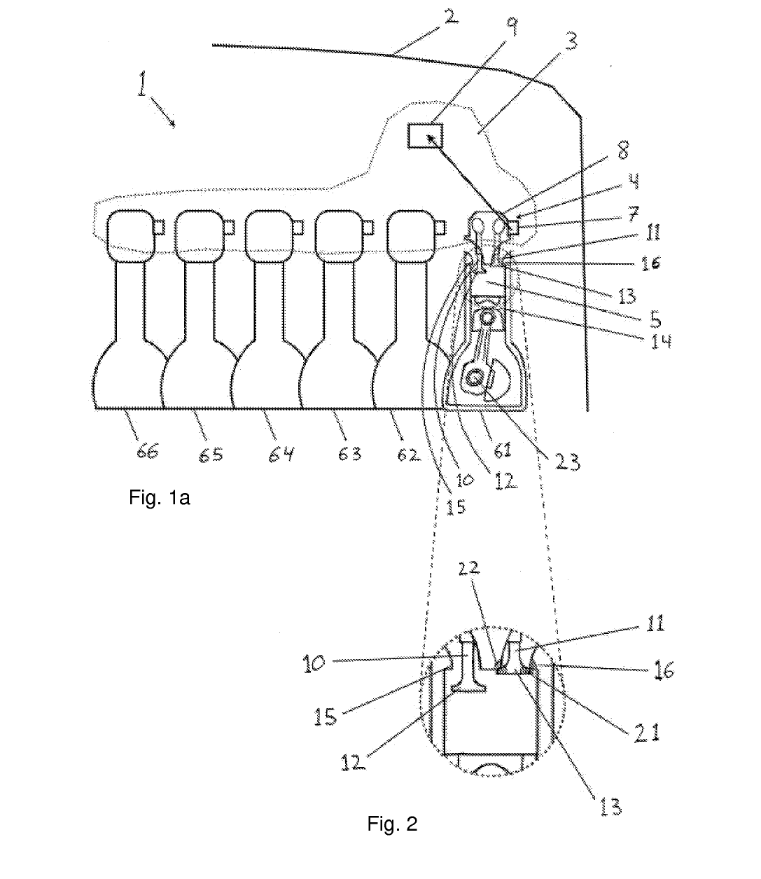

FIG. 1a illustrates very schematically a combustion engine 1 according to one embodiment of the invention, which is here arranged in an implied motor vehicle 2, for example a truck. The engine is equipped with a device 3, indicated with a dashed line, adapted to detect operating conditions in the engine, and such device has a schematically drawn device 4 which is adapted to detect e.g. pressure changes in the cylinder chambers 5 of the combustion engine's cylinders 61-66, of which there are six in this case, but of which there may be any number.

The device 4 has, in order to be able to detect said pressure changes in the cylinder chambers, one sensor element 7 per cylinder 61-66, and this is arranged separately from the associated cylinder chamber 5 on the respective cylinders' cylinder heads 8. The sensor elements in this case consist of piezo resistive sensors adapted to detect pressure changes, for example in the form of vibrations, generated by movements propagated in the cylinder head, caused by the turns of a piston 14 in the respective cylinders 61-66 or by positional changes in the valves 10, 11, arranged in the respective cylinder heads 8.

The fact that said at least one sensor element 7 is arranged separately from the cylinder chamber 5, i.e. the cylinder's 61-66 combustion chambers, means that it does not come into direct contact with the inside volume of the cylinder chamber, but is completely separate therefrom. However, some form of external recess could be adapted in the wall of the cylinder chamber 5, in which a sensor element 7 could be arranged.

The device 3 also comprises a unit 9, which may consist of the vehicle's 2 electronic control device, adapted to receive information about the detected movements from the sensor elements 7, and to compare such information, or information calculated based on such sensor information with stored values, and to deliver measurings of the state of the engine 1 and its component parts and/or processes in the engine, such as positions in inlet-10 and/or outlet valves 11 and the period length for an opening in any of these. Thus, information about the engine's 1 operating conditions or divergences from these, which suitably provide the bases for control of various components in the combustion engine, such as for example fuel injection or an indication of adjustment or service requirements, may be obtained based on the sensor elements' 7 detection.

It has been shown that, by arranging such sensor elements in the manner described, so that they have the ability to detect movements propagating in the cylinder head 8 or in parts adjacent thereto in the engine 1, derived from pressure changes in the cylinder chamber 5, turns of said piston 14 and/or positional changes in said valves 10, 11, high quality signals may be obtained, which signals do not require filtering or further processing, or alternatively, which require a simple filtering or processing, in order to be used at the diagnosis of at least one valve 10, 11 in the at least one cylinder 61-66 of the engine 1.

FIG. 1b shows another placement of the sensor element 7. The sensor element is here placed on a section adjacent to the cylinder head. In this example, the sensor element is placed on the engine, specifically on the engine block. The sensor elements/sensors 7 may be of a suitable type, e.g. piezo resistive or piezo electrical elements or optical sensors. The sensor element may here be placed on the engine, in an area adjacent to the outlet of the exhaust channel from a cylinder. For example, it may be placed on a surface on the engine block next to the outlet, on the engine, of the exhaust channel from a cylinder. The surface where the sensor 7 is placed may be substantially vertical. The sensor may be arranged to detect movements, which are perpendicular to the movements of the piston. The sensor may also be arranged to detect movements, which are perpendicular both in relation to the piston's direction of movement and in relation to the engine's longitudinal direction. In one embodiment, the sensor is located on the engine's long side. The sensor may be arranged to detect movements in a direction, which is perpendicular in relation to the surface on which it is placed.

In another embodiment (not displayed) the sensor element 7 may be placed in a corresponding manner as when placed on the engine at the outlet of the exhaust channel from a cylinder, but instead placed in a corresponding location on the engine at the suction channel's inlet to a cylinder.

The signal detected by the sensor element 7 may be treated in various ways. For example, the following signal treatment steps may be carried out. First the sensor's electrical signal is entered into a control device/signal treatment device. The signal is filtered with a bandpass filter in order to remove superfluous information, which does not belong to the frequency range around which information is required. The signal is evened out by way of filtering, averaging or by being replaced with one or several continuous function(s) with good likeness. Subsequently, the signal is scaled, e.g. with the help of the correlation between pressure and volume at compression. Subsequently, (a) suitable part(s) of the signal is/are transformed to the pressure domain. Supplemental modeling closes gaps in the signal's reliability, in order to form a pressure curve. The thus formed pressure curve is used to calculate different values at engine control. In some embodiments one or several of the steps above may be omitted.

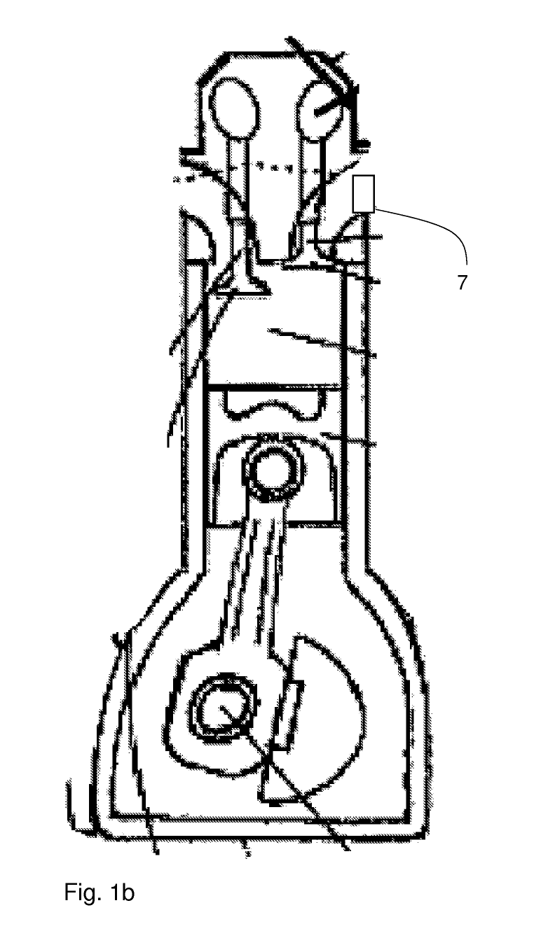

FIG. 2 illustrates an inlet 10 and exhaust valve 11, respectively, and valve seats 15 and 16, respectively, interacting therewith, in a cylinder head 8 of a cylinder 61 in the engine 1. The inlet valve 10 and the associated valve seat 15 are in a normal state, corresponding to the state in newly produced such parts.

The exhaust valve 11 and the associated valve seat 16 are in an error state. This is illustrated by the dashed areas 21, 22 in the valve lid 13 of valve 11 and in the valve seat 16, illustrating worn corners in these, as a result of numerous openings and closings of the valve. When the mentioned areas 21, 22 are worn away, the valve's 11 opening and closing times will be impacted, as will its sealing capacity facing the valve seat. As a consequence of such wear, for example the engine's 1 fuel consumption and exhaust emissions may increase.

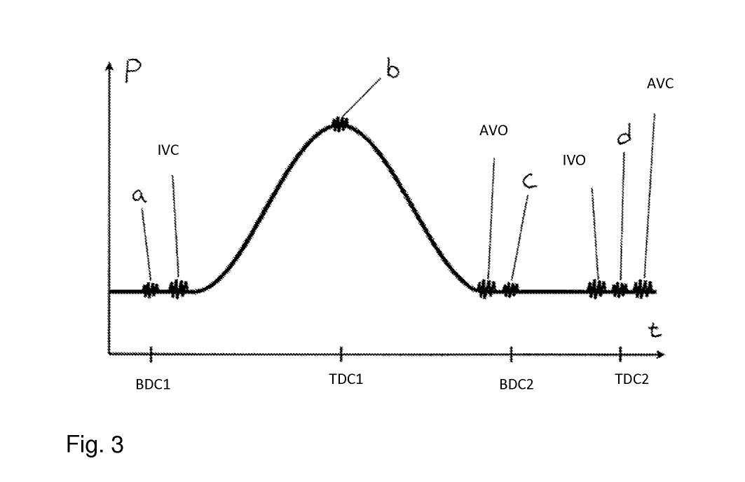

FIG. 3 illustrates in a diagram the development of the pressure P over the time t during a working cycle in a cylinder chamber 5, without combustion in the engine 1 that uses diesel as fuel during operation and works in four strokes, which are referred to hereafter as the suction stroke, the compression stroke, the combustion stroke and the exhaust stroke, and jointly constitute one said working cycle.

The markings BDC1, TDC1, BDC2, TDC2 on the time axis show at what points the piston 14 of a cylinder 61 turns, i.e. is located at a top and bottom dead center, respectively, where BDC1 refers to the piston's turn at a first bottom dead center at the end of the suction stroke, DC1 refers to the piston's turn at a first top dead center at the end of the compression stroke and the beginning of the combustion stroke, BDC2 refers to the piston's turn at a second bottom dead center at the beginning of the exhaust stroke and TDC2 refers to the piston's turn at a second top dead center at the end of the exhaust stroke and the beginning of the suction stroke.

The curve in the diagram shows clearly how the pressure in the cylinder chamber 5 increases between BDC1 and TDC1, reduces between TDC1 and BDC2 and remains substantially constant between BDC2 and TDC2, and between TDC2 and BDC1. At different points along the curve, there may also be noise in the form of noise IVO, IVC illustrating detected vibrations caused by the opening and closing, respectively, of the inlet valve 10, noise AVO, AVC illustrating detected vibrations caused by the opening and closing, respectively, of the exhaust valve 11, and noise a-d illustrating detected vibrations caused by a turn of said piston 14.

The noise IVO, IVC, AVO, AVC illustrating detected movements caused by a positional change of a valve 10, 11 will hereafter be referred to, for the sake of clarity, as valve noise and the noise a-d illustrating detected movements caused by a turn of said piston 14 will, for the same reason, be referred to as piston noise.

The pressure as well as the respective noise in the diagram are examples of movements propagating in a cylinder head 8 of the cylinder 61 or in parts adjacent thereto in the engine 1, detected by the sensor element 7. Attempts have shown that such a sensor element may be used both to detect the pressure and thus to generate signals which correspond, with great reliability, with signals generated by a conventional pressure sensor, and to detect other said movements such as vibrations, which are illustrated by way of said noise a-d, IVO, IVC, AVO, AVC.

The movements and noise thus showed IVO, IVC, AVO, AVC thus shown, deriving from positional changes in said valves 10, 11, are caused by their valve lids 12, 13 hitting against or repelling parts, such as valve seats 15, 16 in the cylinder head 8 at closing and opening, respectively, of said valves, through which vibrations spreading in the cylinder head are created.

The movements, which are shown in the diagram as noise a-d and are derived from turns of said piston 14, are caused because parts of the piston, at turns, come into contact with parts of the cylinder 61 connecting the piston and the crankshaft 23, so that vibrations spreading in the cylinder are created.

The measuring values displayed in the above described diagram may be used in various ways with the help of the device 3, at diagnosis at least one valve 10, 11 in at least one cylinder 61-66 of the engine 1, according to one innovative method.

When a valve noise is detected in a cylinder chamber 5 in a cylinder 61, the device 3 may, with the help of for example a crankshaft positional sensor, determine at what crank angle the noise was detected. The noise in combination with the crank angle is compared with a setpoint value, which comprises information about the crank angles at which the valve noise should be detected, and an error state or a normal state is determined for the at least one valve 10, 11 in the cylinder 61, depending on whether or not the noise was detected at an accepted crank angle. An error state may in this case for example entail wear of a valve 10, 11 or a valve seat 15, 16.

Another way of using valve noise for diagnosis of at least one valve is to detect movements resulting in noise IVO, AVO caused by the opening of a valve 10, 11, and movements resulting in noise IVC, AVC caused by the closing of said valve 10, 11. With the help of, for example, a crank angle positioning sensor, the device 3 may determine the crank angles at which said noise was detected and therefore also the period length of the opening of said valve 10, 11. The measured period length is compared with a setpoint value and a normal state or an error state is determined for said at least one valve 10, 11, depending on whether or not said measured period length is within a predetermined interval around the setpoint value.

An error state may in this case, for example, entail an incorrect valve clearance between a valve 10, 11 and its interacting valve seat 15, 16, because of wear of said valve or valve seat. Too small a valve clearance results in the valve 10, 11 opening too soon and closing too late, and conversely, too large a valve clearance results in the valve opening too late and closing too soon. Both these cases may be devastating for the capability of the engine's 1 processes functioning in a desirable manner, and the valves 10, 11 and valve seats 15, 16 or cylinder head 8 should therefore be adjusted as quickly as possible, or replaced by a service technician.

In order to diagnose one or several valves 10, 11 in a cylinder 61-66 according to another embodiment of the invention, movements caused by a pressure change in the cylinder chamber 5, such as a pressure increase, may be detected at a crank angle, which is determined by for example a crankshaft positional sensor. The detected pressure at the determined crank angle is then compared with a setpoint value, which comprises information about the pressure that should prevail in the cylinder chamber 5 at said determined crank angle, and a normal state or an error state is determined for the at least one valve 10, 11 in the cylinder 61, depending on whether or not the detected pressure is within a predetermined interval around the setpoint value.

An error state may in this case, for example, entail a leakage at one valve 10, 11 and the error may also be diagnosed by measurements of the pressure at difference crank angles via the sensor 7, and a comparison of these measured values with setpoint values for said crank angles during the engine's 1 working cycle.

In the absence of a crankshaft positioning sensor of the engine 1, the device 3 may instead use valve noise IVO, IVC, AVO, AVC resulting from movements detected by the sensor 7, as well as pressure and piston noise a-d, and a value of the engine's actual engine speed, measured with for example some commonly occurring speed sensor, in order to calculate the crank angle at which a valve noise was detected. By detecting the pressure, for example at a determined distance before and after a detected valve noise and a piston noise, the identity of these noises may be determined, for example as an IVC noise and an a noise. As an example of how this method functions, the identity of the noise is determined as IVC, i.e. closure of the inlet valve 10, when the pressure before the valve noise is substantially constant, and the subsequent pressure increases. In order to determine this, the pressure may be measured at several points before and after the noise. When the piston's 14 turn in the first bottom dead center BDC1, illustrated with a piston noise a, occurs at a specific crank angle, the device 3 may, with the help of the engine's current engine speed determine at what crank angle said valve noise IVC was detected.

The noise IVC at the determined crank angle is compared with a setpoint value, which comprises information about the crank angle at which said valve noise should be detected, and an error state or a normal state is determined for the relevant valve 10 in the cylinder 61, depending on whether or not the noise was detected at an accepted crank angle.

A determined error state in for example a valve 10, 11 preferably comprises several, such as two or three, different types and/or degrees of error, which facilitates the decision as to what measures must be taken to correct the error.

At, for example, an error state comprising three different degrees of error, a first degree may represent a less serious error, e.g. in the form of detected valve noise at a crank angle, which is only one crank angle degree or so outside a predetermined interval around a setpoint value, as a consequence of for example wear of a valve 10, 11, which may e.g. result in a signal such as an information error code being sent to the engine's 1 service garage.

A second degree of error may in this example represent a more serious error, e.g. in the form of a detected pressure at a crank angle being a little outside the interval around a setpoint value, which interval comprises accepted values of a pressure around this crank angle. Such an error may, for example, indicate a smaller leakage in a valve 10, 11. Said degree of error state may, for example, result in a warning signal being sent to a driver or an operator who is in charge of the engine's 1 operation, e.g. in the form of lighting of a warning lamp, and the latter may accordingly ensure that the engine 1 is examined within a near future by a service technician.

A third degree of error may in this example represent an extremely serious error, for example in the form of a detected pressure at a crank angle, which is not in the vicinity of a said interval around a setpoint value, as a consequence of, for example, the fact that an exhaust valve 11 is constantly in an open state. Such an error state may, for example, result in the countermeasure that combustion in the relevant cylinder 61-66 is directly prevented, because the fuel injection to the cylinder's cylinder chamber 5 is stopped or because the relevant cylinder is completely disconnected from the engine 1.

The unit 9 in the device 3 may, through the frequency of a noise, determine whether this derives from a turn of said piston 14, which event results in noise a-d with a first frequency, or from a positional change of a valve 10, 11, which event results in noise IVO, IVC, AVO, AVC with a second, higher frequency.

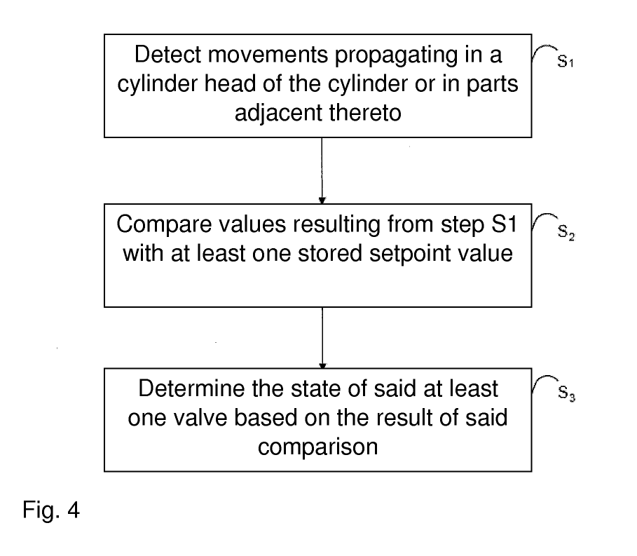

FIG. 4 shows a flow chart illustrating an embodiment of a method according to the present invention, to diagnose at least one valve in at least one cylinder of a combustion engine, when a piston in said cylinder moves. In a first step S₁ propagating movements in a cylinder head of the cylinder or in parts adjacent thereto in the engine are detected, in a second step S₂ the values resulting from step S₁ are compared with at least one stored setpoint value, and in a third step S₃ the state in said at least one valve is determined, based on the result of said comparison.

A computer program code for the implementation of a method according to the invention is suitably included in a computer program, loadable into the internal memory of a computer, such as the internal memory of an electronic control device of a combustion engine. Such a computer program is suitably provided via a computer program product, comprising a data storage medium readable by an electronic control device, which data storage medium has the computer program stored thereon. Said data storage medium is e.g. an optical data storage medium in the form of a CD-ROM, a DVD, etc., a magnetic data storage medium in the form of a hard disk drive, a diskette, a cassette, etc., or a Flash memory or a ROM, PROM, EPROM or EEPROM type memory.

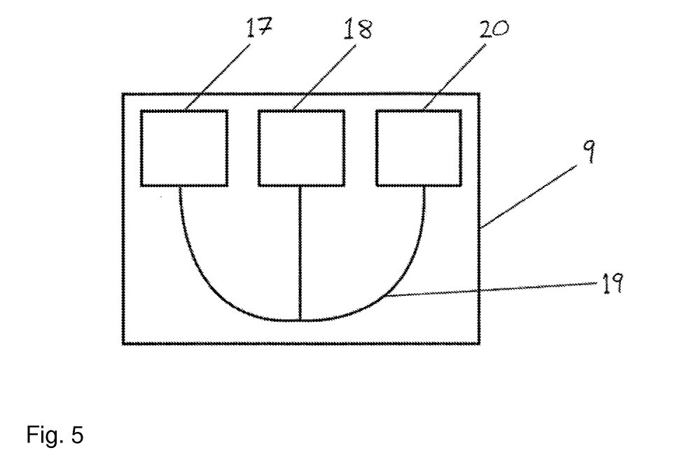

FIG. 5 very schematically illustrates an electronic control device 9 comprising execution means 17, such as a central processor unit (CPU), for the execution of computer software. The execution means 17 communicates with a memory 18, e.g. a RAM memory, via a data bus 19. The control device 9 also comprises a data storage medium 20, e.g. in the form of a Flash memory or a ROM, PROM, EPROM or EEPROM type memory. The execution means 17 communicates with the data storage means 20 via the data bus 19. A computer program comprising computer program code for the implementation of a method according to the invention is stored on the data storage medium 20.

The invention is obviously not limited in any way to the embodiments described above, but numerous possible modifications thereof should be obvious to a person skilled in the area, without such person departing from the spirit of the invention as defined by the appended claims.

For example, the combustion engine could have another number of cylinders than displayed. A sensor element to detect movements derived from the cylinder chambers in all cylinders is also unnecessary, and it is even plausible that the device may have only one sensor element, intended to detect movements derived from pressure changes in only one of the engine's cylinders.

The sensor elements may be adapted to detect said movements also when there is no combustion in the engine's cylinders, but when there are still changes in the pressure inside the cylinder chambers, for example when starting the combustion engine with a starting engine, or when combustion occurs in the engine's cylinder chamber.

The diagram displayed in FIG. 3 is prepared for illustrative purposes and thus the information that may be derived therefrom is not necessarily realistic with respect to scales etc. Corresponding diagrams for different types of engines may also differ in terms of appearance, as a consequence of, for example, different timing of opening and/or closing of a valve in these. For example, valve periods for different valves may overlap each other or follow each other without overlapping.

Detection of movements caused by a pressure change also relates to comprising detection of the absence of such movements, in a sensor element adapted to detect such movements when pressure changes arise. This detected absence then indicates that the pressure is substantially unchanged during a certain time, which indicates that we are currently in, for example, the suction stroke or the exhaust stroke.

A piston which, at a turn, gives rise to movements, such as vibrations, relates to a piston which, when the engine is in operation, carries out a forward and backward movement in the cylinder and therefore operates a crankshaft connected with the piston.

A crank angle at which movements are detected by a said sensor element may be determined with some type of conventional crank angle sensor, such as an inductive crank angle positional sensor, but may also be calculated by the innovative device, based only on the movements detected by said sensor elements.

The described manners in which the innovative device may use movements detected by the sensor element to diagnose at least one valve are examples thereof, and thus not intended to limit the area of use of the invention.

The values described in step S₂ as “resulting from step S₁” and which are compared with a setpoint value may, in addition to being direct values of movements detected by the sensor element, also be composite values, for example calculated values, of such direct values and of values obtained in another manner than as described in step S₁, for example from an engine speed sensor.

A setpoint value may be a value, for example, for a crank angle determined at the manufacture of the engine, at which a certain event should occur, or a value measured and determined previously during the operation of the engine, and also a combination of these.

An interval around a setpoint value specifies accepted values, for example for a crank angle at which a valve is opened, the period length of a valve, or a pressure in a cylinder chamber at such a certain crank angle. As an example, when the setpoint value for such a period length is 220 crank angle degrees, the interval of accepted values may be 216-224 crank angle degrees. Accepted values around a setpoint value, specifying the crank angle at which a valve should be opened, may for example consist of the setpoint value for said opening plus/minus two crank angle degrees.

The number of valves per cylinder may vary from only one inlet valve and outlet valve, respectively, up to three or four of such respective valve types, or even more. The valves in a cylinder that may be diagnosed simultaneously with an innovative method may be one, several or all of said valves, and valves in different cylinders of the engine may also be diagnosed simultaneously.

A valve period relates to the period which begins when the opening of a valve from a closed state takes place, and ends when the valve is in the closed state again. The period length of such a valve period accordingly relates to the distance between the beginning and the end of the period, i.e. the opening and closing of the valve, and is suitably provided as a number of crank angle degrees.

1. A method for diagnosis of at least one valve in at least one cylinder of a combustion engine comprising the steps of, at a movement of a piston in said cylinder:
detecting propagating movements in a cylinder head of the cylinder or in parts adjacent thereto in the engine;
comparing values resulting from said detecting step with at least one stored setpoint value; and
determining the state of said at least one valve based on the result of said comparison.

2. A method according to claim 1, wherein the detection is carried out in or on said cylinder head.

3. A method according to claim 1, wherein the detection is carried out on the engine, in an area adjacent to the outlet of the exhaust channel from a cylinder.

4. A method according claim 1, wherein the detection is carried out on the engine, in an area adjacent to the suction channel's inlet to a cylinder.

5. A method according to claim 1, wherein in said detecting step movements caused by least one of the following events in said cylinder are detected: positional change in at least one valve and pressure change in a cylinder chamber.

6. A method according to claim 5, wherein at least movements caused by a positional change in at last one valve in said cylinder are detected in said detecting step, wherein said movements are detected at least at one crank angle.

7. A method according to claim 6, wherein in said comparing step the value of said at least one crank angle is compared with a setpoint value for a crank angle, at which said movements should be detected.

8. A method according to claim 5, wherein in said detecting step movements caused by at least both said events are detected.

9. A method according to claim 8, wherein in said comparing step values resulting from movements caused by a positional change in at least one valve, a pressure change in a cylinder chamber and a turn of a piston in said cylinder are compared—by way of a calculated value based on information about these and about the engine's current engine speed, comprising information about at least one crank angle at which said movements caused by said positional change was detected—with said at least one setpoint value for a crank angle, at which said movements caused by said positional change should be detected.

10. A method according to claim 8, wherein said movements caused by said positional change in at least one valve are detected at least at two different crank angles, and preferably such movements caused by opening and closing of said valve are detected.

11. A method according to claim 10, wherein in said comparing step values resulting from movements caused by a positional change in at least one valve and a pressure change in a cylinder chamber are compared—based on information about these and about the engine's current engine speed, in the form of a period length of a valve period in said valve with said at least one setpoint value for such a period length.

12. A method according to claim 7, wherein in said determining step an error state is determined, when said value of said at least one crank angle and/or period length is not within a predetermined interval around said setpoint value, and a normal state is determined, when said value of said at least one crank angle and/or period length is within a predetermined interval around said setpoint value.

13. A method according to claim 5, wherein in said detecting step at least movements caused by pressure changes in a cylinder chamber of said cylinder are detected, wherein said movements are detected at least at one crank angle.

14. A method according to claim 13, wherein in said comparing step a stored setpoint value in the form of normal pressure in said cylinder chamber, at least at one determined crank angle, is compared with said value of said detected movements at the at least one determined crank angle, wherein said value of said detected movements comprises information about the pressure in said cylinder chamber.

15. A method according to claim 14, wherein in said determining step an error state is determined, when said value of said detected movements at the at least one crank angle is not within a predetermined interval around said setpoint value, and a normal state is determined, when said value of said detected movements at the at least one crank angle is within a predetermined interval around said setpoint value.

16. A method according to claim 12, wherein an error state comprising at least two different types and/or degrees of error is determined.

17. A method according to claim 1, further comprises:
sending a warning signal and/or preventing fuel injection into the cylinder chamber of the relevant cylinder, when the state of said valve is determined as an error state.

18. A device for diagnosis of at least one valve in at least one cylinder of a combustion engine, wherein said method comprises at least one sensor element, arranged separately from a cylinder chamber in said cylinder on a part of a cylinder head or on parts adjacent thereto in the engine, and adapted to detect, at a movement of a piston in said cylinder chamber, movements propagating in said cylinder head or said parts.

19. A device according to claim 18, wherein said sensor element is arranged in or on said cylinder head.

20. A device according to claim 18, wherein said sensor element is placed on the engine, in an area adjacent to the outlet of the exhaust channel from a cylinder.

21. A device according to claim 18, wherein said sensor element is placed on the engine, in an area adjacent to the inlet of the suction channel to a cylinder.

22. A combustion engine comprising a device for diagnosis of at least one valve in at least one cylinder of a combustion engine, wherein said method comprises at least one sensor element, arranged separately from a cylinder chamber in said cylinder on a part of a cylinder head or on parts adjacent thereto in the engine, and adapted to detect, at a movement of a piston in said cylinder chamber, movements propagating in said cylinder head or said parts.

23. A computer program product comprising computer program code stored on a non-transitory computer-readable medium, which is readable by a computer, said computer program product is used for diagnosis of at least one valve in at least one cylinder of a combustion engine, said computer program code comprising computer instructions to cause one or more computer processors to perform the operations of, at a movement of a piston in said cylinder:
detecting propagating movements in a cylinder head of the cylinder or in parts adjacent thereto in the engine;
comparing values resulting from said detecting step with at least one stored setpoint value; and
determining the state of said at least one valve based on the result of said comparison.

24. (canceled)

25. An electronic control device for a combustion engine, comprising:
an execution means;
a non-transitory computer-readable data storage medium connected to the execution means;
a computer program product comprising computer program code stored on said non-transitory computer-readable medium, which is readable by a computer, said computer program product is used for diagnosis of at least one valve in at least one cylinder of a combustion engine, said computer program code comprising computer instructions to cause one or more computer processors to perform the operations of, at a movement of a piston in said cylinder:
detecting propagating movements in a cylinder head of the cylinder or in parts adjacent thereto in the engine;
comparing values resulting from said detecting step with at least one stored setpoint value; and
determining the state of said at least one valve based on the result of said comparison.

26. A motor vehicle comprising, a combustion engine comprising a device for diagnosis of at least one valve in at least one cylinder of a combustion engine, wherein said method comprises at least one sensor element, arranged separately from a cylinder chamber in said cylinder on a part of a cylinder head or on parts adjacent thereto in the engine, and adapted to detect, at a movement of a piston in said cylinder chamber, movements propagating in said cylinder head or said parts.

27. A motor vehicle according to claim 26, wherein said vehicle is a wheeled motor vehicle or a boat or a crawler.
